(19) United States
(12) Patent Application Publication
(10) Pub. No.: US 2006/0074145 A1
(43) Pub. Date: Apr. 6, 2006

(54) Water-based ink for stencil printing and stencil printing method

(76) Inventors: Hiroshi Hayashi, Ibaraki-ken (JP); Yoshihiro Hayashi, Ibaraki-ken (JP); Yoshifumi Watanabe, Ibaraki-ken (JP)

Correspondence Address: NATH & ASSOCIATES, 112 South West Street, Alexandria, VA, 22314, US

(21) Appl. No.: 11/242,931

(22) Filed: Oct. 5, 2005

(30) Foreign Application Priority Data
Oct. 6, 2004 (JP) P2004-294162

(51) Int. Cl. C03C 17/00; C09D 11/00

(52) U.S. Cl. 523/160; 523/161

(57) ABSTRACT

A water-based ink for stencil printing, wherein the slope (S) of a graph generated by plotting spread meter values measured at 25° C. [x axis: natural logarithm of the time elapsed T (seconds), y axis: spread diameter D (mm)] is within a range from 1.0 to 4.5; a water-based ink for stencil printing that includes a water-soluble polymer thickener with a cross-linked structure, and a water-soluble polymer thickener with a straight-chain structure; and stencil printing methods that use these inks.

### CROSS REFERENCE TO RELATED APPLICATIONS

This Application is based upon and claims the benefit of priority from prior Japanese Application P2004-294162 filed on Oct. 6, 2004; the entire contents of which are incorporated by reference herein.

### BACKGROUND OF THE INVENTION

1. Field of the Invention

The present invention relates to a water-based ink for stencil printing, and more particularly to a water-based ink for stencil printing that is suitable for use in a rotary digital stencil printing machine, as well as a stencil printing method that uses such an ink.

2. Description of the Related Art

Compared with other printing methods such as offset printing, gravure printing, and letterpress printing, stencil printing offers significant advantages in terms of operability and convenience, including not requiring complex operations such as post-use cleaning operations, and not requiring a specialist operator. Since the introduction of thermal stencil making methods that use a thermal printing head as a perforation device, image processing within stencil printing methods has been able to be digitalized, enabling high quality printed products to be produced quickly and with comparative ease, and consequently the convenience of stencil printing continues to gain recognition, even as a method for information processing terminals.

Rotary stencil printing machines, in which the making, loading, and removal operations for the stencil master, as well as the ink supply operation and the printing operation are all controlled automatically, are widely used in offices and schools under names such as digital stencil duplicators.

Inks for stencil printing have conventionally been water-in-oil (W/O) emulsion inks. W/O emulsion inks have a function that inhibits variations in the ink composition or the ink properties when the printing machine is sitting unused, even if the ink inside the machine is in contact with the atmosphere. In other words, the water, which is the inner phase component of the emulsion ink, is covered with the outer phase oil component, meaning evaporation of the water is inhibited.

It is thought that the drying of printed material that has been printed using a W/O emulsion ink proceeds by a mechanism that relies on the penetration of the ink into the gaps between the fibers of the paper that functions as the print target (the print medium), and the gradual separation of the ink into an oil phase and a water phase as a result of contact with the paper fibers, thus enabling the water, which represents the major component of the ink, to contact the atmosphere and evaporate. However, the water within the ink transferred to the print medium is unable to undergo adequate contact with the atmosphere in the short period of time following printing, meaning the drying characteristics immediately following printing rely on drying by penetration. However, because the viscosity of a W/O emulsion ink is designed to be relatively high, the rate of penetration is not particularly fast, meaning the drying characteristics of the ink immediately following printing are not entirely satisfactory.

Improving the drying rate of printed material is an extremely important problem for stencil printing. If the printed material is not dry, the operator is unable to handle the material, and the advantage of stencil printing of “producing high quality printed material in a short time” is partially negated.

Accordingly, water-based inks that can be used for stencil printing, and for which the focus is on rapid drying, have already been proposed, and the development of water-based inks that can be used in printing methods that utilize fixing agents is also being pursued. Furthermore, water-based inks for stencil printing are also being developed due to their improved environmental friendliness and safety, and a stencil printing method in which a base is applied to the printed surface immediately following printing, thereby improving the penetration of the water-based ink into the paper, is already known. In addition, it is also known that using a water-based ink for stencil printing enables variations in the ink viscosity on the squeegee roller inside the printing drum to be inhibited (see Japanese Laid-Open Publication No. 2001-302955).

However, although conventional water-based inks for stencil printing have enabled significant improvement in the post-printing drying characteristics, during repetition of the series of operations associated with normal use of a printing machine, namely stencil production, printing, and then stopping of the printing machine, the behavior of water-based inks inside the printing machine tends to be unstable, and a number of problems arise which are not observed when conventional W/O emulsion inks are used. The behavior of the ink on the squeegee roller is a particularly large problem.

Specifically, when the movement of the printing drum is started and stopped repeatedly, for example during repetition of the operations for stencil production and printing, the behavior of ink vortex on the squeegee roller inside the printing drum becomes unstable, and the ink may ride up onto the doctor roller without passing through the squeegee gap. If this quantity of ink that is transferred to the doctor roller is large, then ink may make contact with the residual ink detection sensor, meaning even if the quantity of ink on the squeegee roller for supply to the interior surface of the printing drum is inadequate, replenishment of the ink on the squeegee roller may not occur. As a result, an ink supply shortage can arise, causing incomplete ink coverage or “faint and patchy” of the image, and eventually leading to a state where the image is not printed at all. In addition, when the printing drum is stopped, the ink can drip off the squeegee roller, causing excessive ink supply to the interior surface of the printing drum, which can lead to density irregularities within the printed product, and leakage of ink from the printing drum. These phenomena can also occur during periods when printing is halted within the normal operations of stencil production and printing.

### SUMMARY OF THE INVENTION

The present invention relates to a water-based ink for stencil printing, wherein the slope (S) of a graph generated by plotting spread meter values measured at 25° C. [x axis: natural logarithm of the time elapsed T (seconds), y axis: spread diameter D (mm)] is within a range from 1.0 to 4.5.

Another aspect of the present invention relates to a water-based ink for stencil printing that comprises a water-soluble polymer thickener with a cross-linked structure, and a water-soluble polymer thickener with a straight-chain structure.

In addition, yet another aspect of the present invention relates to a stencil printing method that uses a water-based ink for stencil printing according to either of the above aspects of the present invention.

### BRIEF DESCRIPTION OF THE DRAWINGS

FIG. 1 is a graph showing measured values (time and spread diameter) from a spread meter for inks obtained in examples of the present invention.

FIG. 2 is a graph showing measured values (time and spread diameter) from a spread meter for inks obtained in comparative examples.

### DETAILED DESCRIPTION OF THE EMBODIMENTS

A water-based ink for stencil printing (hereafter, the term “water-based ink for stencil printing” is abbreviated as simply “ink”) according to a first aspect of the present invention comprises water, a colorant, and a thickener, wherein the slope (S) of a graph generated by plotting spread meter values measured at 25° C. [x axis: natural logarithm of the time elapsed T (seconds), y axis: spread diameter D (mm)] is within a range from 1.0 to 4.5.

A spread meter is an apparatus in which an ink sample is sandwiched between two horizontally-positioned parallel plates, the weight of the load plate (115 g) is used to cause the ink to spread out concentrically, and the spread diameter is then observed and measured over time. This measurement method is conducted in accordance with JIS K5701-1. In the ink and printing industries, the spread diameter after 1 minute is referred to as the “flow”, and is sometimes used as a measure of the ink viscosity. Generally, by adjusting the nature and quantity of the thickener used, this flow value (the 1 minute value) can be set to a desired value.

The inventors of the present invention tested a wide variety of thickener combinations, and evaluated the relationship between this 1 minute value and the behavior of the ink inside the printing drum. As a result, they discovered that the behavior of the ink inside the printing drum varied considerably even for inks with the same 1 minute value. On further investigation of these inks, the inventors discovered that a favorable correlation existed between the slope (S) of a graph generated by plotting the measured values from the spread meter (x axis: natural logarithm of the time elapsed T, y axis: spread diameter D), and the behavior of the ink inside the printing drum. In addition, this correlation between the slope and the ink behavior inside the printing drum was not observed for W/O emulsion inks, indicating the phenomenon is unique to water-based inks.

The slope (S) is calculated using the formula shown below.

$$S = \frac{{D}_{2} - {D}_{1}}{{log}_{e} ( {T}_{2} / {T}_{1} )}$$

(wherein, D₁ is the spread diameter (mm) after T₁ seconds, D₂ is the spread diameter (mm) after T₂ seconds, T. and T₂ are elapsed times (seconds), and T₂>T₁)

Furthermore, the ink spread diameter D (mm) satisfies the relationship below.
D=S×logₑT(seconds)+a(mm)
(wherein, a represents the spread meter intercept (the y-axis intersection for T=1))

In those cases where the slope (S) of the spread meter values is less than 1.0, the behavior of the ink vortex during printing becomes unstable, and the ink rides up onto the doctor roller and makes contact with the residual ink detection sensor, causing the problem described above wherein printing of the image becomes impossible. It is thought that this finding indicates that the ink has become unable to track the movement of the squeegee roller. In contrast, in those cases where the slope (S) exceeds 4.5, ink drips off the squeegee roller onto the interior surface of the printing drum when printing is stopped, meaning when printing is recommenced, the excess ink on the interior surface of the printing drum causes irregularities in the print density on the printed material. Furthermore, if the quantity of ink that drips onto the interior surface of the printing drum is large, then ink may leak from the printing drum.

In order to ensure even more favorable ink vortex suitability, the slope (S) is preferably within a range from 1.3 to 4.0, and is even more preferably from 1.5 to 3.0.

A slope that falls within the above range can be achieved by appropriate adjustment of the nature (the molecular structure, chemical composition, etc.) and the blend quantity of the thickener used within the ink. One example involves the use of a water-soluble polymer thickener with a cross-linked structure and/or a water-soluble polymer thickener with a straight-chain structure as the ink thickener, and a method that uses a combination of these two types of thickener is a particularly preferred embodiment.

A water-soluble polymer thickener with a cross-linked structure (hereafter abbreviated as simply a “cross-linked thickener”) refers to a polymer with a network structure in which either one, or two or more polymers are cross-linked together via chemical bonds (covalent bonds). The formation of the network structure may occur simultaneously with the polymerization, or a straight-chain polymer may be synthesized first, and a chemical reaction then used to effect cross-linking. In addition, the cross-linking may be formed by an addition polymerization reaction (radical polymerization, anionic polymerization, or cationic polymerization or the like) in the presence of a divinyl compound, or by a polycondensation reaction of a polyfunctional compound. In the case of cross-linking by an addition reaction, radical polymerization is the most common method, and this radical reaction may be either initiated by an initiator, or initiated by heat, light, radiation, or a plasma.

Examples of favorable cross-linked thickeners include unsaturated carboxylic acid-based resins (unsaturated carboxylic acid-based water-soluble polymers) such as acrylic acid-based resins. An unsaturated carboxylic acid-based water-soluble polymer refers to a water-soluble polymer comprising a repeating unit represented by a formula (1) shown below: 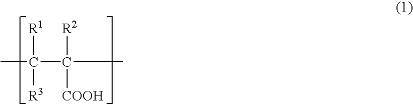
(wherein, R¹, R², and R³ each represent, independently, H, CH₃, or (CH₂)ₙCOOH (wherein, n is either 0 or 1)). In those cases where a polymer contains 2 or more carboxyl groups, these carboxyl groups may also form an acid anhydride group. In the case of a copolymer, a random, alternate, block, or graft copolymer may be used.

Examples of this unsaturated carboxylic acid-based thickener include water-soluble polymers comprising, within the principal chain, one or more unsaturated carboxylic acids selected from the group consisting of acrylic acid and methacrylic acid (hereafter, these two are referred to jointly using the generic term (meth)acrylic acid), maleic anhydride, maleic acid, fumaric acid, crotonic acid, and itaconic acid, as well as the salts thereof. Specific examples include poly(meth)acrylic acid, acrylic acid-methacrylic acid copolymers, (meth)acrylic acid-maleic acid copolymers, (meth)acrylic acid-sulfonic acid-based monomer copolymers, (meth)acrylic acid-itaconic acid copolymers, (meth)acrylate ester-maleic acid copolymers, (meth)acrylic acid-(meth)acrylamide copolymers, (meth)acrylic acid-(meth)acrylate ester copolymers, (meth)acrylic acid-vinylpyrrolidone copolymers, polymaleic acid, polyfumaric acid, polycrotonic acid, polyitaconic acid, maleic anhydride-alkyl vinyl ether copolymers, as well as salts of these polymers.

The salts are preferably monovalent metal salts or amine salts, and specific examples of suitable salts, using polyacrylic acid as an example, include sodium polyacrylate, potassium polyacrylate, ammonium polyacrylate, and triethanolamine polyacrylate. Neutralized aqueous solutions prepared by mixing together, in water, a non-neutralized unsaturated carboxylic acid-based thickener and an alkaline neutralizing agent such as sodium hydroxide, potassium hydroxide, triethanolamine, or diisopropanolamine can also be used.

The above cross-linked thickener can be used either alone, or in combinations of two or more different thickeners.

A water-soluble polymer thickener with a straight-chain structure (hereafter abbreviated as simply a “straight-chain thickener”) refers to a polymer that does not adopt the type of cross-linked structure described above. Specific examples include alginic acid-based thickeners such as sodium alginate and propylene glycol alginate; cellulose-based thickeners such as methylcellulose, ethylcellulose, carboxymethylcellulose, hydroxyethylcellulose, hydroxypropylcellulose, and hydroxypropylmethylcellulose; and polyurethane-based thickeners. In addition, unsaturated carboxylic acid-based water-soluble polymers such as those described above, but with a straight-chain structure are also suitable. These thickeners can be used either alone, or in combinations of two or more different materials.

As described above, the cross-linked thickener and the straight-chain thickener differ in terms of molecular chain structure, and depending on the polymer, a cross-linked polymer and a straight-chain polymer with the same chemical composition may coexist.

The quantity of the cross-linked thickener within the ink is preferably within a range from 0.1 to 5% by weight. The quantity of the straight-chain thickener within the ink is preferably within a range from 0.01 to 10% by weight. In those cases where both types of thickener are used, the combined quantity of the two thickeners is preferably within a range from 0.11 to 10.1% by weight.

If the blend quantity of the cross-linked thickener is insufficient, and particularly in those cases where only a straight-chain thickener is used, the slope (S) tends to become very large. In contrast, if the blend quantity of the straight-chain thickener is insufficient, and particularly in those cases where only a cross-linked thickener is used, the slope (S) decreases regardless of how much cross-linked thickener is added, meaning there tends to be almost no spreading observed when the load is applied to the ink. Accordingly, by combining the two thickeners, the slope (S) can be controlled with comparative ease. However, even when a cross-linked thickener or straight-chain thickener is used alone, by appropriate selection of factors such as the molecular structure, and the chemical composition, and the blend quantity of the thickener, a slope (S) that falls within the desired range can still be achieved, meaning an ink with favorable ink vortex suitability can still be produced.

In a preferred embodiment of the first aspect of the present invention, one or more other thickeners different from those described above may also be used if desired. In any case, the quantity of thickeners within the ink varies depending on factors such as the type of thickeners used and the desired level of ink viscosity, although generally, consideration of the activity of the thickeners and the associated costs means that total thickener quantities within a range from 0.1 to 10% by weight are preferred.

Examples of other thickeners different from those described above include clay mineral-based thickeners that have neither straight-chain structures nor cross-linked structures, including smectite-based clay minerals such as montmorillonite, hectorite, and saponite. Furthermore, examples of thickeners that may adopt either a straight-chain structure or a cross-linked structure include plant-based natural polymers such as gum arabic, carageenan, guar gum, locust bean gum, pectin, tragacanth gum, corn starch, konjac mannan, and agar; microbial natural polymers such as pullulan, xanthan gum, and dextrin; animal-based natural polymers such as gelatin, casein, and animal glue; starch-based semisynthetic polymers such as hydroxyethyl starch, sodium carboxymethyl starch, and cyclodextrin; sodium hyaluronate; and synthetic polymers such as polyvinylpyrrolidone, polyvinyl alcohol, polyvinyl methyl ether, poly-N-vinylacetamide, polyethylene oxide, and polyethyleneimine.

In the case of W/O emulsion inks, as already mentioned above, there is no correlation between the slope (S) and the stability of the ink behavior inside the printing drum. For example, the slopes for commercially available stencil printing inks include a slope of 1.1 for RISOSOY ink RP (black) (manufactured by Riso Kagaku Corporation), and a slope of 0.48 for Priport ink i-80 (black) (manufactured by Ricoh Company, Ltd.), and neither of these inks exhibits unstable behavior within the printing machine. The reason for this observation is thought to reflect the fact that whereas a water-based ink has a surface constituted of water, with a high surface tension, and consequently does not conform readily with target materials, the outer phase of a W/O emulsion ink is constituted of oil, with a low surface tension, and consequently readily wets a variety of materials ranging from polymer materials through to metals, meaning the ink readily tracks the movement of the squeegee roller even if the slope of the spread meter values is small. Furthermore, the structure of W/O emulsion inks is imparted with a powerful degree of structural viscosity, meaning dripping of the ink is unlikely to occur even if the slope of the spread meter values is large.

From the viewpoint of improving the drying characteristics of the printed material, water preferably accounts for at least 50% by weight, and even more preferably 65% by weight or more, of the ink. The water contained within the ink can evaporate into the atmosphere immediately following printing. In addition, it is thought that by forcing the ink to penetrate into the gaps between the fibers of the printing paper during printing, the contact surface area between the ink and the air expands rapidly within the interior of the printing paper, further improving the evaporation rate of the water, and as a result, increasing the quantity of water further improves the drying characteristics of the printed material. Although there are no particular restrictions on the upper limit for the blend quantity of the water, the quantity is preferably set to ensure a favorable balance with the other components of the ink.

In order to preventing drying of the ink within the perforated portions of the stencil master during printing, a water-soluble organic solvent is preferably also added to the ink.

The water-soluble organic solvent is a liquid at room temperature, and is soluble in water. Suitable examples include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, pentaethylene glycol, propylene glycol, dipropylene glycol, and tripropylene glycol; glycerol; acetins (monoacetin, diacetin, and triacetin); glycol derivatives such as triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, β-thiodiglycol, and sulfolane. Low molecular weight polyalkylene glycols, including polyethylene glycol with an average molecular weight within a range from 190 to 630, such as an average molecular weight of 200, 300, 400, or 600, polypropylene glycol diol with an average molecular weight within a range from 200 to 600, such as an average molecular weight of 400, and polypropylene glycol triol with an average molecular weight within a range from 250 to 800, such as an average molecular weight of 300 or 700, can also be used. These water-soluble organic solvents can be used either alone, or in combinations of two or more different solvents.

The quantity of the water-soluble organic solvent within the ink is preferably at least 5% by weight, and even more preferably 10% by weight or greater. Although there are no particular restrictions on the upper limit for this quantity, in order to avoid image show through, the quantity is preferably no more than approximately 45% by weight, and even more preferably no more than approximately 35% by weight. By incorporating at least 5% by weight of a water-soluble organic solvent with a higher boiling point than water, and preferably a boiling point of at least 150° C., drying of the perforated portions of the stencil master during printing can be effectively prevented.

The colorant can use either pigments or dyes, or a combination of two or more such colorants. Suitable pigments include organic pigments such as azo-based pigments, phthalocyanine-based pigments, dye-based pigments, condensed polycyclic pigments, nitro-based pigments, and nitroso-based pigments (such as brilliant carmine 6B, lake red C, Watchung red, disazo yellow, Hansa yellow, phthalocyanine blue, phthalocyanine green, alkali blue, and aniline black); inorganic pigments, including metals such as cobalt, iron, chrome, copper, zinc, lead, titanium, vanadium, manganese, and nickel, as well as metal oxides, metal sulfides, yellow ocher, ultramarine, and iron blue pigments; and carbon blacks such as furnace carbon black, lamp black, acetylene black, and channel black. Suitable dyes include those basic dyes, acid dyes, direct dyes, soluble vat dyes, acid mordant dyes, mordant dyes, reactive dyes, vat dyes, and sulfide dyes that are water soluble, as well as those dyes that have been converted to a water-soluble form through reduction or the like. Either pigments and/or dyes can be used as the colorant, but the use of pigments is preferred, as they enable production of an ink that exhibits minimal bleeding or image show through, and excellent weather resistance.

The quantity of colorant within the ink is preferably within a range from 1 to 20% by weight, and even more preferably from 3 to 10% by weight. In order to maximize the print density of the printed material, the colorant quantity is preferably at least 5% by weight.

In a preferred embodiment, the ink may also include suitable quantities of pigment dispersing agents, fixing agents, antifoaming agents, surface tension reduction agents, pH regulators, antioxidants, and preservatives, in addition to the components described above.

An alkali-soluble resin may also be added to the ink as a fixing agent for improving the fixation of the colorant to the print target such as the printing paper. In those cases where a pigment is used as the colorant, an alkali-soluble resin can also be used as a pigment dispersing agent.

Examples of suitable alkali-soluble resins include styrene-(meth)acrylic acid copolymers, styrene-α-methylstyrene-(meth)acrylic acid copolymers, styrene-(meth)acrylate ester-(meth)acrylic acid copolymers, styrene-maleic anhydride copolymers, vinylnaphthalene-(meth)acrylic acid copolymers, vinylnaphthalene-maleic acid copolymers, isobutylene-maleic anhydride copolymers, (meth)acrylate ester-(meth)acrylic acid copolymers, and acrylate ester-methacrylate ester-(meth)acrylic acid copolymers. A combination of two or more of these resins may also be used. These alkali-soluble resins can be neutralized and converted to a water-soluble form using a suitable alkali, including an alkali metal hydroxide such as sodium hydroxide or potassium hydroxide, ammonia water, or an alkanolamine such as triethanolamine.

If a large quantity of alkali-soluble resin is added, then there is a danger of interfering with the printing performance of the printing machine following a period of non-use, and consequently the quantity of alkali-soluble resin within the ink, calculated as a solid fraction percentage, is preferably no more than 5% by weight, and even more preferably 3% by weight or less.

An oil-in-water (O/W) resin emulsion can also be incorporated within the ink, and used as a fixing agent for fixing the colorant to the printing paper or the like that functions as the print target (the print medium). In those cases where a pigment is used as the colorant, this resin emulsion can also be used as a pigment dispersing agent.

Examples of suitable oil-in-water (O/W) resin emulsions include emulsions of polyvinyl acetate, ethylene-vinyl acetate copolymers, vinyl acetate-(meth)acrylate ester copolymers, poly(meth)acrylate, polystyrene, styrene-(meth)acrylate ester copolymers, styrene-butadiene copolymers, vinylidene chloride-(meth)acrylate ester copolymers, polyvinyl chloride, vinyl chloride-vinyl acetate copolymers, and polyurethane and the like. Combinations of two or more of these emulsions may also be used.

If a large quantity of resin emulsion is added, then there is a danger of interfering with the printing performance of the printing machine following a period of non-use, and consequently the quantity of resin emulsion within the ink, calculated as a solid fraction percentage, is preferably no more than 5% by weight, and even more preferably 2% by weight or less.

The water-soluble polymers listed above as thickeners can also be used as fixing agents for improving the fixation of the colorant to the printing paper, depending on the nature and the quantity of the polymer. Furthermore, in those cases where a pigment is used as the colorant, the water-soluble polymers can also be used as pigment dispersing agents.

Extender pigments may also be added to the ink to improve the image quality of the printed material. Examples of suitable extender pigments include white clay, talc, clay, diatomaceous earth, calcium carbonate, barium carbonate, barium sulfate, alumina white, silica, kaolin, mica, and aluminum hydroxide, and combinations of two or more of these extender pigments may also be used.

If a large quantity of extender pigment is added, then there is a danger of inhibiting the fixation of the colorant to the print target, and interfering with the printing performance of the printing machine following a period of non-use, and consequently the quantity of extender pigment is preferably no more than 5% by weight, and even more preferably 2% by weight or less.

In addition, anionic surfactants, cationic surfactants, amphoteric surfactants, nonionic surfactants, or polymer-based, silicone-based or fluorine-based surfactants may also be added to the ink as pigment dispersing agents, antifoaming agents, or surface tension reduction agents or the like.

An electrolyte may also be added to the ink to allow regulation of the ink viscosity or pH. Examples of suitable electrolytes include sodium sulfate, potassium hydrogenphosphate, sodium citrate, potassium tartrate, and sodium borate, and combinations of two or more of these electrolytes may also be used. Other materials such as sulfuric acid, nitric acid, acetic acid, sodium hydroxide, potassium hydroxide, ammonium hydroxide, and triethanolamine and the like may also be used in the ink as thickening assistants or pH regulators.

By adding an antioxidant, oxidation of the ink components can be prevented, and the stability of the ink can be improved. Examples of suitable antioxidants include L-ascorbic acid, sodium L-ascorbate, sodium isoascorbate, potassium sulfite, sodium sulfite, sodium thiosulfate, sodium dithionite, and sodium pyrosulfite.

By adding a preservative, degradation of the ink can be prevented, enabling the storage stability to be improved. Examples of suitable preservatives include isothiazolone-based preservatives such as 5-chloro-2-methyl-4-isothiazolin-3-one, 2-methyl-4-isothiazolin-3-one, 2-n-octyl-4-isothiazolin-3-one, and 1,2-benzoisothiazolin-3-one; triazine-based preservatives such as hexahydro-1,3,5-tris(2-hydroxyethyl)-s-triazine; pyridine or qionoline-based preservatives such as sodium 2-pyridinethiol-1-oxide and 8-oxyquinoline; dithiocarbamate-based preservatives such as sodium dimethyldithiocarbamate; organobromine-based preservatives such as 2,2-dibromo-3-nitrilopropionamide, 2-bromo-2-nitro-1,3-propanediol, 2,2-dibromo-2-nitroethanol, and 1,2-dibromo-2,4-dicyanobutane; as well as methyl p-hydroxybenzoate, ethyl p-hydroxybenzoate, potassium sorbate, sodium dehydroacetate, and salicylic acid.

The ink can be produced by mixing water, the colorant, and the thickener, together with any of the other optional components described above as desired. For example, a portion of the water, the pigment, and a pigment dispersing agent is mixed together, and a dispersion device such as a ball mill or beads mill is used to disperse the pigment, while the remainder of the water, the thickener, and the water-soluble organic solvent are also mixed together, before the two separate mixtures are then combined and mixed.

The most appropriate range for the ink viscosity varies depending on factors such as the printing pressure of the printing apparatus, but is typically within a range from approximately 0.5 to approximately 20 Pa·s (the viscosity is measured at 20° C., using a shear rate of 100/s), and (pseudo) plastic flow characteristics are ideal for stencil printing.

An ink according to the second aspect of the present invention comprises water, a colorant, a water-soluble polymer thickener with a cross-linked structure, and a water-soluble polymer thickener with a straight-chain structure. By using a combination of a thickener with a cross-linked structure and a thickener with a straight-chain structure, an ink can be provided that exhibits stable behavior inside the printing machine and favorable vortex characteristics.

Specific examples of each of the components added to this ink, and the respective blend quantities used, are the same as those described above for the first aspect of the present invention.

A stencil printing method according to the present invention is conducted using an ink according to the first or second aspect of the present invention described above. Specifically, the method comprises: preparing a stencil master; and pressing the produced stencil master and a print target together, thereby causing the ink of the present invention to pass through the perforated portions of the stencil master and onto the print target.

There are no particular restrictions on the printing machine used, although because of their superior operability, digital stencil printing machines are preferred.

### EXAMPLES

As follows is a more detailed description of the present invention using a series of examples, although the present invention is in no way limited by these examples. In the following description, the units “% by weight” are abbreviated simply as “%”.

### Example 1

4.5% of carbon black (Raven 1080, manufactured by Columbian Carbon Co., Ltd.) as a colorant, 4.5% of hexaglyceryl monolaurate (Hexaglyn 1-L, manufactured by Nikko Chemicals Co., Ltd.) as a pigment dispersing agent, and 10.0% of distilled water were mixed together, and were then dispersed thoroughly using a beads mill, thus yielding a pigment dispersion. 0.5% of sodium polyacrylate (Rheogic 250H, manufactured by Nihon Junyaku Co., Ltd.) as a cross-linked thickener was dissolved in 10.0% of distilled water, yielding a cross-linked thickener aqueous solution. Furthermore, 1.0% of sodium alginate (manufactured by Kanto Chemical Co., Inc.) as a straight-chain thickener was dissolved in 20.0% of distilled water, yielding a straight-chain thickener aqueous solution.

The 19.0% of the thus obtained pigment dispersion, 10.5% of the cross-linked thickener aqueous solution, 21.0% of the straight-chain thickener aqueous solution, 13.0% of ethylene glycol as an organic solvent, and the remaining quantity of distilled water (36.5%) were then mixed together, yielding an ink of the example 1.

### Examples 2 to 6, Comparative Examples 1 to 7

With the exception of using the blend ratios shown in Table 1 and Table 2, inks for each of the examples and comparative examples were prepared in the same manner as the example 1. In Table 1 and Table 2, the straight-chain sodium polyacrylate refers to Aronvis S, manufactured by Nihon Junyaku Co., Ltd., the sodium carboxymethylcellulose is manufactured by Kanto Chemical Co., Inc., and the polyurethane polymer refers to Bermodol PUR 2150 (an aqueous solution with a solid fraction of 35%), manufactured by Akzo Nobel N.V.

In the examples 2, 4, and 6, and the comparative examples 1 to 4, a polyacrylic acid copolymer (Carbopol 940, manufactured by BF Goodrich Company) was used as the cross-linked thickener, and in each case, the predetermined quantity shown in the table was dissolved in 10.0% of distilled water, and the predetermined quantity of triethanolamine shown in the table was then added to effect a neutralization and complete preparation of the cross-linked thickener aqueous solution.

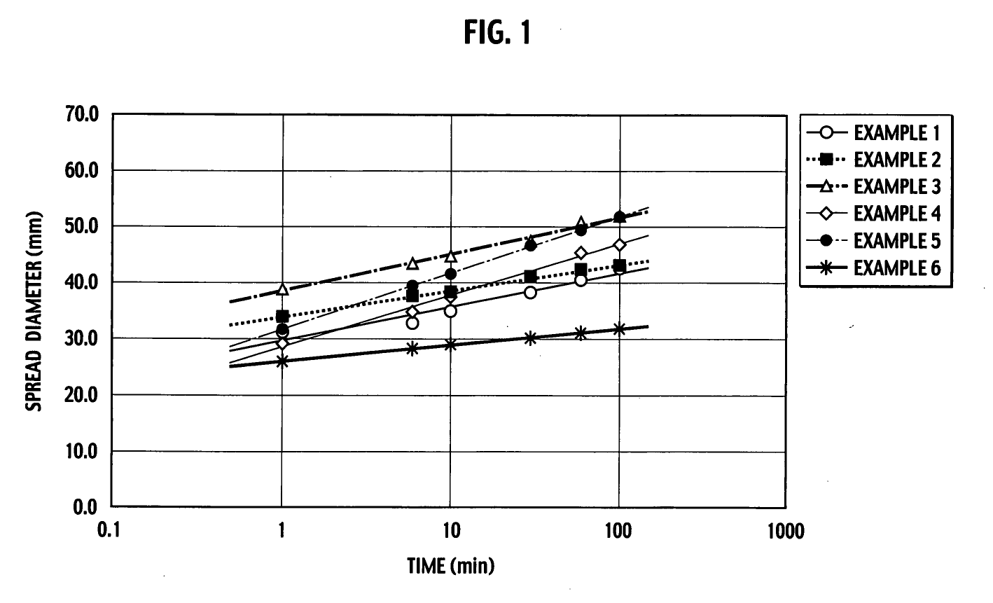

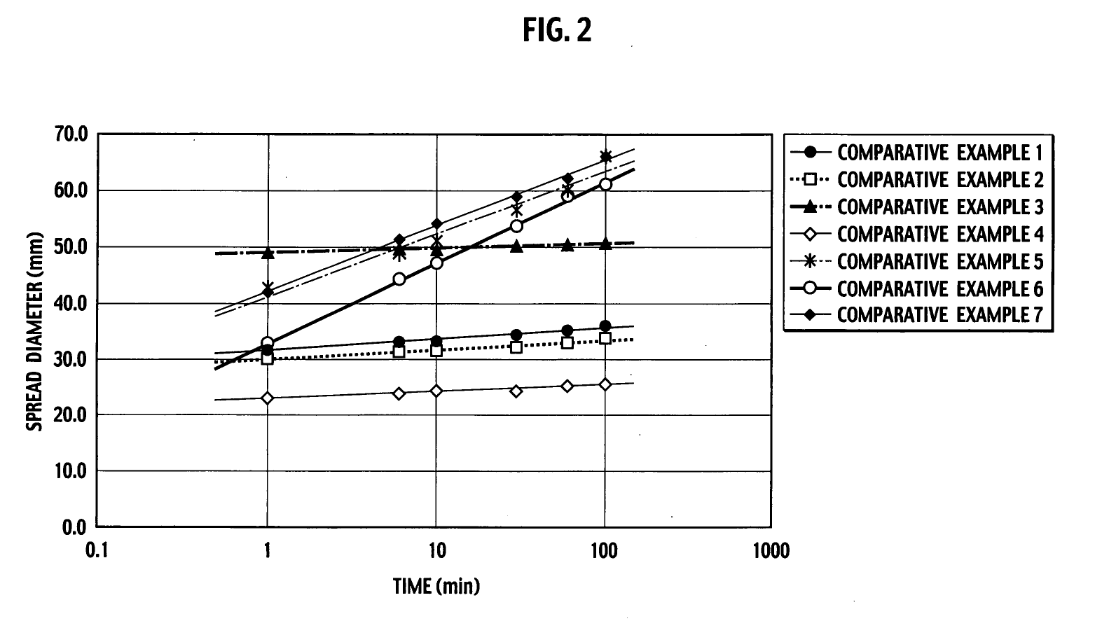

Measurement of the spread meter values for each of the prepared inks was conducted in accordance with JIS K 5701-1. The measurement results are shown in FIG. 1 (for the examples) and FIG. 2 (for the comparative examples). Measurements were made after 1 second, 6 seconds, 10 seconds, 30 seconds, 60 seconds, and 100 seconds, and the measurements for each ink were repeated three times. The average value of the three spread diameter values at each elapsed time was used as the measurement value, and the slope and flow (the 1 minute value) were determined.

Using each of the prepared inks, stencil production and printing were conducted using a stencil printing machine (RISO RP3700, manufactured by Riso Kagaku Corporation). Riso lightweight paper manufactured by Riso Kagaku Corporation was used as the printing paper. With one cycle defined as stencil production and the subsequent printing of 1,000 copies, this cycle was repeated 5 times, and the quality of the printed material, and the existence of ink leakage from the printing drum were checked for each cycle. In addition, the touch-dry characteristics of the printed material were also evaluated by a touch test.

This touch test involved touching the printed material following printing, and measuring the length of time required before the ink would no longer transfer to the finger. If this time was no more than 10 seconds, the ink was recorded using the evaluation A, a time of 10 to 20 seconds was recorded using the evaluation B, and a time exceeding 20 seconds was recorded using the evaluation C.

The results are shown in Table 1 and Table 2.

TABLE 1

| | | % by weight | | | | | |
|---|---|---|---|---|---|---|---|
| | | Example | | | | | |
| Blend ratio | | 1 | 2 | 3 | 4 | 5 | 6 |
| Colorant | Carbon black | 4.5 | 4.5 | 4.5 | 4.5 | 4.5 | 4.5 |
| Pigment | Hexaglyceryl | 4.5 | 4.5 | 4.5 | 4.5 | 4.5 | 4.5 |
| dispersing agent | monolaurate | | | | | | |
| Water-soluble | Ethylene glycol | 13.0 | 13.0 | 13.0 | 13.0 | 13.0 | 13.0 |
| organic solvent | | | | | | | |
| pH regulator | Triethanolamine | — | 1.0 | — | 0.4 | — | 1.0 |
| Straight-chain | Sodium alginate | 1.0 | — | — | 1.0 | — | — |
| thickener | Sodium polyacrylate | — | 0.5 | — | — | — | — |
| | Sodium | — | — | 1.0 | — | — | — |
| | carboxymethylcellulose | | | | | | |
| | Polyurethane polymer | — | — | — | — | 68.0 | 15.0 |
| | (solid fraction: 35%) | | | | | | |
| Cross-linked | Sodium polyacrylate | 0.5 | — | 1.0 | — | — | — |
| thickener | Polyacrylic acid | — | 0.5 | — | 0.2 | — | 0.5 |
| | copolymer | | | | | | |
| Distilled water | | 76.5 | 76.0 | 76.0 | 76.4 | 10.0 | 61.5 |
| Total | | 100.0 | 100.0 | 100.0 | 100.0 | 100.0 | 100.0 |
| Results | Slope (S) | 2.6 | 2.1 | 2.8 | 3.9 | 4.4 | 1.3 |
| | Flow value (mm) | 40.3 | 42.3 | 50.3 | 45.3 | 49.0 | 30.7 |
| | Image quality | uniform | uniform | uniform | uniform | uniform | uniform |
| | Ink leakage | none | none | none | none | none | none |
| | Touch-dry | A | A | A | A | B | A |
| | characteristics | | | | | | |

TABLE 2

| | | % by weight | | | | | | |
|---|---|---|---|---|---|---|---|---|
| | | Comparative Example | | | | | | |
| Blend ratio | | 1 | 2 | 3 | 4 | 5 | 6 | 7 |
| Colorant | Carbon black | 4.5 | 4.5 | 4.5 | 4.5 | 4.5 | 4.5 | 4.5 |
| Pigment | Hexaglyceryl | 4.5 | 4.5 | 4.5 | 4.5 | 4.5 | 4.5 | 4.5 |
| dispersing agent | monolaurate | | | | | | | |
| Water-soluble | Ethylene glycol | 13.0 | 13.0 | 13.0 | 13.0 | 13.0 | 13.0 | 13.0 |
| organic solvent | | | | | | | | |
| pH regulator | Triethanolamine | 1.0 | 1.0 | 0.2 | 2.0 | — | — | — |
| Straight-chain | Sodium alginate | — | — | — | — | 1.0 | — | — |
| thickener | Sodium polyacrylate | — | — | — | — | 0.5 | — | — |
| | Sodium | — | — | — | — | — | — | 2.5 |
| | carboxymethylcellulose | | | | | | | |
| | Polyurethane polymer | — | — | — | — | — | 37.0 | — |
| | (solid fraction: 35%) | | | | | | | |
| Cross-linked | Sodium polyacrylate | — | 1.0 | — | — | — | — | — |
| thickener | Polyacrylic acid | 0.5 | 0.5 | 0.1 | 1.0 | — | — | — |
| | copolymer | | | | | | | |
| Distilled water | | 76.5 | 75.5 | 77.7 | 75.0 | 76.5 | 41.0 | 75.5 |
| Total | | 100.0 | 100.0 | 100.0 | 100.0 | 100.0 | 100.0 | 100.0 |
| Results | Slope (S) | 0.9 | 0.7 | 0.3 | 0.5 | 4.8 | 6.2 | 5.1 |
| | Flow value (mm) | 35.0 | 33.0 | 50.3 | 25.0 | 60.0 | 59.0 | 62.0 |
| | Image quality | faint and | faint and | — | faint and | irregular | irregular | irregular |
| | | patchy in | patchy in | | patchy in | density in | density in | density in |
| | | 2nd cycle | 1st cycle | | 1st cycle | 2nd cycle | 1st cycle | 1st cycle |
| | Ink leakage | none | none | — | none | leaked in | leaked in | leaked in |
| | | | | | | 4th cycle | 3rd cycle | 4th cycle |
| | Touch-dry | A | A | A | A | A | A | A |
| | characteristics | | | | | | | |

With the inks from the examples, even after 5 repetitions of the “produce stencil, print 1,000 copies” cycle, there was no change in the image quality, and no leakage of ink from the printing drum was observed.

The printed material obtained in the examples 1 to 4, and the example 6 also exhibited excellent drying characteristics. The ink of the example 5 had a water content of 54.2%, which is comparatively lower than that of the other examples, and as a result, the drying characteristics were somewhat inferior.

In contrast, with the inks from the comparative examples 1, 2, and 4, faint and patchy occurred in the printed material during the second, first, and first cycles respectively. In each case, when the printing drum was disassembled and the interior inspected, it was found that ink had ridden up onto the doctor roller, and a portion of that ink had adhered to the residual ink detection sensor. When this ink was removed from the doctor roller, the image quality returned to normal, but repeating the stencil production and printing cycle resulted in the image again becoming faint and patchy.

With the ink of the comparative example 3, the quantity of ink transferred to the paper was excessive, and the printed paper was unable to be separated from the printing drum, meaning the image quality and touch-dry characteristics of the printed material could not be evaluated.

With the inks from the comparative examples 5 to 7, print density irregularities occurred in the printed image during the second, first, and first cycles respectively, and moreover, ink leakage from the printing drum was observed during the fourth, third, and fourth cycles respectively. In each case, when the printing drum was disassembled and the interior inspected, large quantities of ink were found in various locations on the interior surface of the printing drum.

By comparing the example 1 with the comparative example 5, and the example 2 with the comparative example 2 it is clear that even for thickeners of the same chemical composition (sodium polyacrylate), varying the chemical structure generates a large difference in the printing performance. Furthermore, by comparing the example 6 with the comparative examples 2 and 4 it is clear that the problems cannot be resolved simply by adjusting the spread meter flow value (the 1 minute value). As is evident from a comparison of the comparative examples 1, 3, and 4, imparting favorable vortex characteristics cannot be achieved solely by adjusting the quantity of thickener used. It is also clear from a comparison of the examples 5 and 6 that by combining a thickener with a straight-chain structure and a thickener with a cross-linked structure, the total quantity of thickener can be reduced dramatically, which is very desirable in terms of both cost and the resulting drying characteristics.

As is evident from the results described above, an ink according to the present invention produces printed material with excellent drying characteristics, and exhibits stable ink behavior inside the printing drum, even on repetition of the series of operations associated with normal use of a printing machine, namely stencil production, printing, and then stopping of the printing machine. In particular, the behavior of the ink vortex on the squeegee roller is stable, and problems such as the ink riding up onto the doctor roller, dripping from the squeegee roller, or leaking from the printing drum do not arise (namely, the ink exhibits favorable vortex characteristics). Accordingly, by using an ink according to the present invention, disassembly and adjustment of the printing machine is not required after each print run, and a uniform printed image can be obtained with ease at all times.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A water-based ink for stencil printing, wherein a slope (S) of a graph generated by plotting spread meter values measured at 25° C. [x axis: natural logarithm of time elapsed T (seconds), y axis: spread diameter D (mm)] is within a range from 1.0 to 4.5.

2. The water-based ink for stencil printing according to claim 1, wherein the ink comprises a water-soluble polymer thickener with a cross-linked structure and a water-soluble polymer thickener with a straight-chain structure as thickeners.

3. The water-based ink for stencil printing according to claim 2, wherein the water-soluble polymer thickener with a straight-chain structure comprises one or more thickeners selected from the group consisting of alginate-based thickeners, cellulose-based thickeners, polyurethane-based thickeners, and unsaturated carboxylic acid-based thickeners.

4. The water-based ink for stencil printing according to claim 2, wherein the water-soluble polymer thickener with a cross-linked structure is an unsaturated carboxylic acid-based thickener.

5. A water-based ink for stencil printing, comprising a water-soluble polymer thickener with a cross-linked structure and a water-soluble polymer thickener with a straight-chain structure.

6. The water-based ink for stencil printing according to claim 5, wherein a quantity of the water-soluble polymer thickener with a cross-linked structure is within a range from 0.1 to 5% by weight, a quantity of the water-soluble polymer thickener with a straight-chain structure is within a range from 0.01 to 10% by weight, and a combined quantity of both thickeners is within a range from 0.11 to 10.1% by weight.

7. A stencil printing method that uses the water-based ink for stencil printing according to claim 1.

8. A stencil printing method that uses the water-based ink for stencil printing according to claim 5.
